(19) United States
(12) Patent Application Publication
(10) Pub. No.: US 2002/0157240 A1
(43) Pub. Date: Oct. 31, 2002

(54) Method for producing a flat coil

(76) Inventor: Jerry Perkowsky, Deptford, NJ (US)

Correspondence Address: ABELMAN FRAYNE & SCHWAB, Attorneys at Law, 150 East 42nd Street, New York, NY, 10017, US

(21) Appl. No.: 10/021,585

(22) Filed: Dec. 12, 2001

Related U.S. Application Data
(60) Provisional application No. 60/254,853, filed on Dec. 12, 2000.

(51) Int. Cl. H01F 7/06; H01F 27/30

(52) U.S. Cl. 29/606; 29/602.1; 336/205

(57) ABSTRACT

A method for producing a flat coil of cable coiled into a single layer coil comprising the steps of: holding an end of the cable; tautening the cable; tight-coiling the total length of the flat cable in spiral around itself, maintaining a spiral form and avoiding the unwinding of the cable; attaching holding means around the flat coil once the total length of the cable is coiled in order to maintain the stiffness of the flat coil.

### BACKGROUND OF THE INVENTION.

The present invention is related to methods for producing coils of cables and more particularly to a method for producing a flat coil of cable coiled into a single layer coil without the need of a reel.

### A. FIELD OF THE INVENTION

The most commonly used method for packaging and transporting great lengths of cable is by winding the cable around a reel which may have any size.

However, the above referred method is not suitable for packaging and transporting small lengths of cable (such as a half-meter) mainly because the smallest reels available, are oversized and occupy a lot of space and therefore are unsuitable for containing very smalls lengths of cable.

In view of the above referred necessity, applicant developed a method for producing a flat coil of cable coiled into a single layer coil which does not need any reel and which can be carried out only by hand or automatically by a machine.

Applicant's method comprises the steps of: holding an end of the cable; tautening the cable; tight-coiling the total length of the flat cable in spiral around itself, maintaining a spiral form and avoiding the unwinding of the cable; attaching holding means around the flat coil once the total length of the cable is coiled in order to maintain the stiffness of the flat coil.

Thanks to the method of the present invention, is possible to package and sell small amounts of cable in specific sell points, wherein the cable contained in large reels is commonly sell in smaller pieces.

Furthermore, by method of the present invention, is produced an attractive and practical cable package which may be sell in places such as supermarkets, wherein small lengths of cable coming from large reels can not be sell.

The flat coil produced by the method of the present invention occupies a small space and can be stored in stacks or in rows inside containers, saving a lot of space.

### SUMMARY OF THE INVENTION.

It is therefore a main objective of the present invention, to provide a method for producing a flat coil of cable coiled into a single layer coil which does not need any reel.

It is also a main objective of the present invention, to provide a method for producing a flat coil of cable of the above disclosed nature, which can be carried out only by hand or automatically by a machine.

It is another objective of the present invention, to provide a method for producing a flat coil of cable of the above disclosed nature, by which is possible to package and sell small amounts of cable in specific sell points, wherein the cable contained in large reels is commonly sell in smaller pieces.

It is an additional objective of the present invention, to provide a method for producing a flat coil of cable of the above disclosed nature, by which is produced an attractive and practical cable package which may be sell in places such as supermarkets, wherein small lengths of cable coming from large reels can not be sell.

It is another main objective of the present invention, to provide a method for producing a flat coil of cable of the above disclosed nature, by which is produced a flat coil which occupies a small space and can be stored in stacks or in rows inside containers, saving a lot of space.

These and other objectives and advantages of the present invention will be apparent to those persons having ordinary skill in the art, from the following detailed description of the invention.

### BRIEF DESCRIPTION OF THE DRAWINGS

FIG. 1 is a frontal view of the flat coil produced with the method of the present invention, including a pair of metallic rods which are used for avoiding the unwinding of the cable during the coiling of the cable.

FIG. 2 is a frontal view of the flat coil produced with the method of the present invention, including holding means comprising a pair of radial binding straps.

FIG. 3 is a frontal view of the flat coil produced with the method of the present invention, including holding means comprising a diametric strap.

FIG. 4 is a frontal view of the flat coil produced with the method of the present invention, including holding means comprising a pair of radial binding straps and a shrink wrapped plastic film.

### DETAILED DESCRIPTION OF THE INVENTION

The method for producing a flat coil of flat cable including a first and a second end, will now be described in accordance with a preferred embodiment thereof and making reference to the accompanying drawings wherein the same signs and numbers refer to the same parts of the shown figures, wherein the method of the present invention comprising the steps of:

holding the first end 1 of the flat cable;

tautening the flat cable by pulling it;

tight-coiling the total length of the flat cable in spiral around itself, maintaining the spiral form and avoiding the unwinding of the cable by the use of two pair of guides which may be comprised by two pairs of elongated metallic rods 2, 2′ between which the cable is coiled;

retire the two pair of guides 2, 2′ when the total length of the cable is coiled into a single layer coil;

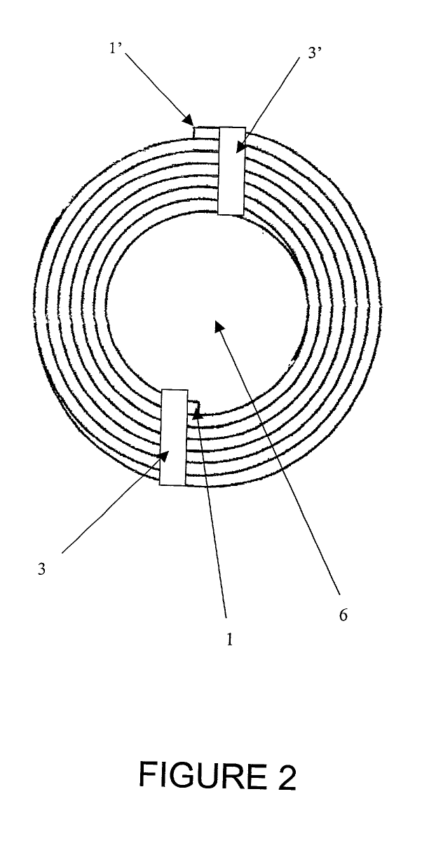

immediately attaching holding means around the flat coil in order to maintain the stiffness of the flat coil, said holding means comprising a pair of radial binding straps 3, 3′ holding both ends 1, 1′ of the cable as shown in “FIG. 2”; and

releasing the first end 1 of the flat cable;

Although it was described that the guides comprise two pair of elongated members they may be comprised by any other suitable means, such as a pair of flat plaques (not shown) between which the cable is coiled.

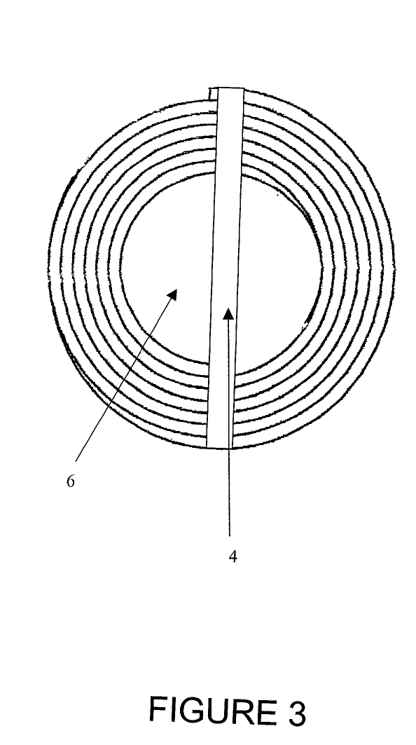

In the same way, the holding means may be comprised by a diametric strap 4 holding both ends of the cable as shown in “FIG. 3”.

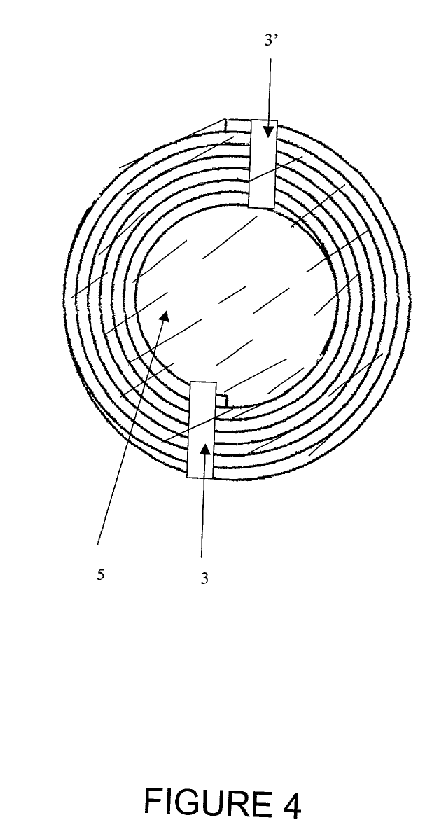

Furthermore, the holding means may be further comprised by a shrink wrapped plastic film 5 wrapping the flat coil as shown in “FIG. 4”, which may be used together with the radial 3, 3′ or diametric binding straps 4, or the flat coil may be held together only with the shrink wrapped film 5.

In case of using the shrink wrapped plastic film 5, independently of whether the radial or diametric binding straps are used or not, firstly, the first end of the cable 1 must be released before wrapping the flat coil.

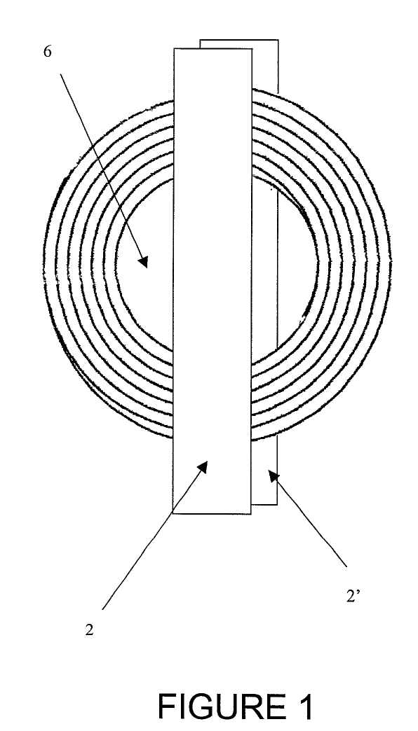

The flat coil produced by the method of the present invention, may have an inner air core 6 as shown in “FIG. 1”, “FIG. 2”, “FIG. 3” and “FIG. 4”, but obviously, the flat cable may be coiled so tightly that the inner air core may be inexistent.

It has to be understood that the method of the present invention may be carried out only by hand or with the aid of any suitable instrument. It can be even carried out automatically by a machine.

Finally it must be understood that the method of the present invention, is not limited exclusively to the above described and illustrated embodiments and that the persons having ordinary skill in the art can, with the teaching provided by this invention, be enabled to make modifications to the process of the present invention, which will clearly will be within the true inventive concept and scope of the invention which is claimed in the following claims.

What is claimed is:

1. A method for producing a flat coil of cable coiled into a single layer coil, said cable including two ends and said method comprising the steps of:
a) holding an end of the cable;
b) tautening the cable;
c) tight-coiling the total length of the flat cable in spiral around itself, avoiding the unwinding of the cable;
d) attaching holding means around the flat coil once the total length of the cable is wound, in order to maintain the stiffness of the flat coil.

2. The method as claimed in claim 1, wherein in step c), the unwinding of the cable is avoided by the use of two pairs of elongated members between which the cable is coiled.

3. The method as claimed in claim 1, wherein in step c), the spiral is maintained by the use of a pair of flat plaques between which the cable is wound.

4. The method as claimed in claim 1, wherein in step d) the holding means comprise shrink-wrapped plastic film surrounding the flat coil.

5. The method as claimed in claim 1, wherein in the step d) the holding means comprise a pair of radial binding straps holding both ends of the cable.

6. The method as claimed in claim 1, wherein in the step d) the holding means comprise a diametric strap holding both ends of the cable.

7. The method as claimed in claim 1, further including the step of releasing the end of the flat cable.

8. The method as claimed in claim 1, wherein in the step d) the holding means comprise a film of shrink wrapped plastic film, which is wrapped around the flat coil.

9. The method as claimed in claim 1, wherein in the step d) the holding means comprise a film of shrink wrapped plastic film, which is wrapped around the flat coil, and a pair of radial binding straps holding both ends of the cable.

10. The method as claimed in claim 1, wherein in the step d) the holding means comprise a film of shrink wrapped plastic film, which is wrapped around the flat coil, and a diametric strap holding both ends of the cable.

11. The method as claimed in claim 1, wherein in the step d) the holding means comprise a film of shrink wrapped plastic film, which is wrapped around the flat coil, and further including the step of releasing the end of the cable.

12. A flat coil of cable coiled into a single spiral layer coil of cable including holding means for ensuring the stiffness of the flat coil.

13. A flat coil as claimed in claim 12, wherein the holding means comprise a pair of radial binding straps holding both ends of the cable.

14. A flat coil as claimed in claim 12, wherein the holding means comprises a diametric strap holding both ends of the cable.

15. A flat coil as claimed in claim 12, wherein the holding means comprises a shrink wrapped plastic film wrapped around the flat coil.

16. A flat coil as claimed in claim 12, wherein the holding means comprise a shrink wrapped plastic film wrapped around the flat coil and a pair of radial binding straps holding both ends of the cable.

17. A flat coil as claimed in claim 12, wherein the holding means comprise a shrink wrapped plastic film wrapped around the flat coil and a diametric strap holding both ends of the cable.
